(19) United States
(12) Patent Application Publication
(10) Pub. No.: US 2011/0228984 A1
(43) Pub. Date: Sep. 22, 2011

(54) SYSTEMS, METHODS AND ARTICLES FOR VIDEO ANALYSIS

(75) Inventors: Norbert Gernot Papke, Vancouver (CA); Bartholomeus T. W. Klijsen, Surrey (CA); Avner Moshkovitz, Vancouver (CA); Brian Douglas McKenzie, Burnaby (CA)

(73) Assignee: LightHaus Logic Inc., Vancouver (CA)

(21) Appl. No.: 13/049,656

(22) Filed: Mar. 16, 2011

Related U.S. Application Data
(60) Provisional application No. 61/340,382, filed on Mar. 17, 2010.

(51) Int. Cl. G06K 9/00

(52) U.S. Cl. 382/103

(57) ABSTRACT

A video analysis system including a video output device monitoring an area for activity, a video analyzer processing output of the video output device and identifying an event in near-real-time, and a persistent database archiving the event for an operational lifetime of the video analysis system and accessible in near-real-time.

### CROSS REFERENCE TO RELATED APPLICATIONS

This application claims benefit under 35 U.S.C. 119(e) to U.S. provisional patent application Ser. No. 61/340,382 filed Mar. 17, 2010 which is incorporated herein by reference in its entirety.

### BACKGROUND

1. Field

The present systems, methods and articles relate generally to analyzing video and more particularly a system, method and article related to video analytics.

2. Description of the Related Art

Video analytics is a technology that is used to analyze video for specific data, behavior, objects or attitude. It has a wide range of applications including safety and security. Video analytics employ software algorithms run on processors inside a computer or on an embedded computer platform in or associated with video cameras, recording devices, or specialized image capture or video processing units. Video analytics algorithms are integrated with video and called Intelligent Video Software systems that run on computers or embedded devices (e.g., embedded digital signal processors) in IP cameras or encoders or other image capture devices. The technology can evaluate the contents of video to determine specified information about the content of that video.

Examples of video analytics applications include: counting the number of pedestrians entering a door or geographic region, determining a location, speed and direction of travel, identifying suspicious movement of people or assets.

Video analytics should not be confused with traditional Video Motion Detection (VMD), a technology that has been commercially available for over 20 years. VMD uses simple rules and assumes that any pixel change in the scene is important. One limitation of VMD is that there are an inordinate number of false alarms.

### BRIEF SUMMARY

A video analysis system may be summarized as including a video output device monitoring an area for activity, a video analyzer processing output of the video output device and identifying an event in near-real-time, and a persistent database archiving event metadata representing the event for an operational lifetime of the video analysis system and accessible in near-real-time.

The video analysis system may include a temporary database storing output of the video output device. The video analysis system may include an evaluator post-processing the event metadata and an additional set of event metadata. The evaluator may identify a macro event. The macro event may be represented by macro-event metadata which is archived in the persistent database and accessible in near-real-time. The macro event is selected from the group consisting of: an estimation of a wait time, an amount of time the object dwells within a region of the area, determination of a demographic of a person, identification of an unattended item, and identification of a removed object. The evaluator may validate an occurrence of the event. The additional event may be selected from the group consisting of: a second event identified by the video analyzer, a third event identified by a second video analyzer, a non-video related event and a macro event identified by a second evaluator. The event may be identified at least five seconds before the additional event is identified. The event metadata representing the additional event may be archived by the video analysis system and accessible in near-real-time. The video analysis system may include a remote connection to at least one of the temporary database and the persistent database. The remote connection may be used to access the event metadata archived by the persistent database in near-real-time. The persistent database may be copied to a remote database over the remote connection. At least one of the events may be selected from the group consisting of: identification of a face, classification of a face, identification of a moving object, determination of a speed of the moving object, determination of an acceleration of the moving object, identification of a stationary object, identification of a removed object, identification of a path taken by an object moved between a first region of the area and a second region of the area, and identification of an operational state of the video analysis system. The evaluator may produce a graphical representation of data collected by the video analysis system. The graphical representation of data may be at least one of a track heatmap and a dwell heatmap.

A method of video analytics may be summarized as including recording a video stream of an area, identifying an event recorded by the video stream with a video analyzer in near-real-time, and archiving event metadata that represents the event in a persistent database.

The method may include accessing the event metadata in the persistent database from a remote connection in near-real-time. The method may include triggering a notification system after identification of at least one the event and a macro event. The method may include analyzing the event and an additional event using the event metadata. The method may include producing a graphical representation of data collected by the video analysis system. The additional event may be selected from the group consisting: a second event identified by the video analyzer, a third event identified by a second video analyzer, a non-video related event and a macro event identified by a second evaluator. The method may include estimating a wait time. The method may include determining a demographic of a person. The method may include identifying an unattended item. The method may include determining an amount of time the object dwells within a region of the area. The event may be identified at least five seconds before the additional event is identified. The method may include identifying a removed item. The method of may include archiving macro-event metadata that represents a macro event identified by analyzing the event and the additional event in the persistent database. An event recorded by the video stream with a video analyzer in near-real-time may include at least one of identifying a face, identifying a moving object, determining a speed of the moving object, determining an acceleration of the moving object, identifying a stationary object, identification of a removed object, identifying a path taken by an object moved between a first region of the area and a second region of the area, and identifying an operational state of the video analysis system. The method may include archiving an image from the video stream in the persistent database after a predetermined amount of time as passed. The method may include temporarily storing the video stream in a temporary database.

A method of operating a video analysis system may be summarized as including temporarily storing a temporal sequence of digitized images of an area to be monitored by a first temporary storage component which includes at least one non-transitory storage medium to which the digitized images are temporarily stored; overwriting the digitized images temporarily stored by the at least one non-transitory storage medium of the first temporary storage component with new digitized images on a first relatively frequent basis; processing at least a portion of the temporal sequence of the digitized images by a processor of a first image analyzer to identify an occurrence of at least one event of a defined set of events which occurs in the area to be monitored; in response to identification of at least one event, producing by the at least one processor of the first image analyzer a set of event metadata including a set of non-image information that represents the at least one event in a non-image form; and storing the set of event metadata by a persistent event storage component which includes at least one non-transitory storage medium to store the set of event metadata without all of the digitized images on which the identification of the occurrence of the event was based, on a second relatively long term basis relative to the first relatively frequent basis. Identifying the occurrence of at least one event of the defined set of events the at least one processor of the analyzer identify may include comparing at least two of the sequential images, in at least near-real time of a capture of the at least two of the sequential images by at least one camera. Storing the set of event metadata by a persistent event storage component on the second relatively long term basis may include storing the set of event metadata for an operational lifetime of the video analysis system and overwriting the digitized images temporarily stored by the at least one non-transitory storage medium of the first temporary storage component with new digitized images on the first relatively frequent basis includes overwriting on a period that is at least two orders of magnitude shorter than a period of the second relatively long term basis.

The method wherein the first temporary storage component is located locally with respect to at least one camera and the persistent event storage component is located locally with respect to the video analyzer may further include transferring the digitized images from the at least one camera to the first image analyzer via a dedicated communications connection; and transferring the set of event metadata from the first image analyzer to the persistent event storage component via a network communications connection.

Processing at least a portion of the temporal sequence of the digitized images by a processor of a first image analyzer to identify an occurrence of at least one event of a defined set of events which occurs in the area to be monitored may include identifying a face in at least a portion of the area to be monitored, identifying a moving object in at least a portion of the area to be monitored, evaluating a speed of a moving object in at least a portion of the area to be monitored with respect to a threshold speed, evaluating an acceleration of a moving object in at least a portion of the area to be monitored with respect to a threshold acceleration, identifying a stationary object in at least a portion of the area to be monitored, or identifying a path taken by an object that moves between a first portion and a second portion of the area to be monitored.

The method may further include post-processing at least two sets of event metadata by at least one processor of an evaluator; and in response, producing at least one set of macro-event metadata by the at least one processor of the evaluator.

The method may further include storing the at least one set of macro-event metadata to the persistent event storage component by the at least one processor of the evaluator. Producing at least one set of macro-event metadata by the at least one processor of an evaluator may include producing the at least one set of macro-event metadata indicative of at least one of an estimation of a wait time in at least a portion of the area to be monitored, an amount of time an object dwells within at least a portion of the area to be monitored, a determination of a demographic characteristic of a person in the area to be monitored, an occurrence of an unattended item left in the area to be monitored, and an identification of an object being removed from the area to be monitored.

The method may further include validating an occurrence of the at least one event by the at least one processor of the evaluator. Post-processing by the at least one processor of the evaluator may include post-processing a first set of event metadata generated by the first image analyzer and at least a second set of event metadata generated based on information sensed by a non-image based sensor.

The method may further include producing a graphical representation of at least one of the sets of event metadata or macro-event metadata by the at least one processor of the evaluator. Producing a graphical representation of at least one of the sets of event metadata or macro-event metadata may include providing at least one of a track map indicative of a frequency of passage through at least a portion of the area to be monitored or a dwell map indicative of a dwell time in at least a portion of the area to be monitored. The persistent event storage component may be remotely accessible in near-real-time over a non-dedicated network connection.

The method may further include identifying a current operational state of the video analysis system; and producing a set of event metadata in response to identification of at least one defined operational state.

A video analysis system may be summarized as including a first temporary storage component communicatively coupled to at least one camera to receive a temporal sequence of digitized images of an area to be monitored from the at least one camera, the first temporary storage component including at least one non-transitory storage medium to which the digitized images are temporarily stored and overwritten with new digitized images on a first relatively frequent basis; a first image analyzer communicatively coupled to the first temporary storage component, the first image analyzer including at least one processor and at least one non-transitory instruction storage medium that stores processor executable instructions which when executed by the at least one processor cause the at least one processor to process at least a portion of the temporal sequence of the digitized images to identify an occurrence of at least one event of a defined set of events which occurs in the area to be monitored and in response, to produce a set of event metadata including a set of non-image information that represents the at least one event in a non-image form; and a persistent event storage component communicatively coupled to receive the set of event metadata, the persistent event storage component including at least one non-transitory storage medium to store the set of event metadata without all of the digitized images on which the identification of the occurrence of the event was based on a second relatively long term basis with respect to the first relatively frequent basis. The processor executable instructions may cause the at least one processor of the analyzer to identify the occurrence of at least one event of the defined set of events based on a comparison at least two of the sequential images, in at least near-real time of the capture of the at least two of the sequential images by the at least one camera. The second relatively long term basis may be equal to an operational lifetime of the video analysis system and the first relatively frequent basis is at least two orders of magnitude shorter than the second relatively long term basis. The first temporary storage component may be located locally with respect to the at least one camera and communicatively coupled to the first image analyzer via a dedicated communications connection and the persistent event storage component is located locally with respect to the video analyzer and communicatively coupled to the first temporary storage component via a network communications connection. The processor executable instructions may cause the at least one processor of the image analyzer to automatically process the images for, and produce the set of event metadata in response to, an identification of a face in at least a portion of the area to be monitored, an identification of a moving object in at least a portion of the area to be monitored, an evaluation of a speed of a moving object in at least a portion of the area to be monitored with respect to a threshold speed, an evaluation of an acceleration of a moving object in at least a portion of the area to be monitored with respect to a threshold acceleration, an identification of a stationary object in at least a portion of the area to be monitored, or an identification of a path taken by an object that moves between a first portion and a second portion of the area to be monitored.

The video analysis system may further include an evaluator communicatively coupled to the persistent event storage component, the evaluator including at least one processor and at least one non-transitory instruction storage medium that stores processor executable instructions which when executed by the at least one processor cause the at least one processor to post-process at least two sets of event metadata and in response produce at least one set of macro-event metadata. The processor executable instructions may cause the at least one processor of the evaluator to store the at least one set of macro-event metadata to the persistent event storage component. The processor executable instructions may cause the at least one processor of the evaluator to produce the at least one set of macro-event metadata indicative of at least one of an estimation of a wait time in at least a portion of the area to be monitored, an amount of time an object dwells within at least a portion of the area to be monitored, a determination of a demographic characteristic of a person in the area to be monitored, an occurrence of an unattended item left in the area to be monitored, and an identification of an object being removed from the area to be monitored. The processor executable instructions may cause the at least one processor of the evaluator to validate an occurrence of the at least one event. The processor executable instructions may cause the at least one processor of the evaluator to post-process the at least two sets of event meta data in the form of a first set of event metadata generated by the first image analyzer and at least a second set of event metadata generated based on information sensed by a non-image based sensor. The processor executable instructions may cause the at least one processor of the evaluator to produce a graphical representation of at least one of the event metadata or macro-event metadata. The processor executable instructions may cause the at least one processor of the evaluator to produce a graphical representation of at least one of the event metadata or macro-event metadata in the form of at least one of a track map indicative of a frequency of passage through at least a portion of the area to be monitored or a dwell map indicative of a dwell time in at least a portion of the area to be monitored. The persistent event storage component may be remotely accessible in near-real-time over a non-dedicated network connection.

The processor executable instructions may cause the at least one processor of the image analyzer to identify a current operational state of the video analysis system and to produce a set of event metadata in response to an occurrence of at least one defined operational state. The video analysis system may include the image capture device and at least one non-image based sensor.

### BRIEF DESCRIPTION OF THE SEVERAL VIEWS OF THE DRAWINGS

FIG. 1 is a schematic diagram of a video analysis system in accordance with an illustrated embodiment of the present systems and methods.

FIG. 2 is a schematic diagram of a computing system that forms a component of the video analysis system of FIG. 1 in accordance with an illustrated embodiment of the present systems and methods.

FIG. 3 is a schematic diagram of a retail location monitored by a video analysis system in accordance with an illustrated embodiment of the present systems and methods.

FIG. 4 is a schematic diagram illustrating an embodiment of a method of video analytics in accordance with an aspect of the present systems and methods.

FIG. 5 is a schematic diagram illustrating an embodiment of a method of video analytics in accordance with an aspect of the present systems and methods.

FIG. 6A is a schematic diagram illustrating an embodiment of a method of video analytics in accordance with an aspect of the present systems and methods.

FIG. 6B is a schematic diagram illustrating an embodiment of a method of video analytics in accordance with an aspect of the present systems and methods.

FIG. 7 is a schematic diagram illustrating an embodiment of a method of video analytics in accordance with an aspect of the present systems and methods.

FIG. 8A is an exemplary screen print of a track “heatmap” illustrating an embodiment of a method of video analytics in accordance with an aspect of the present systems and methods.

FIG. 8B is an exemplary screen print of a dwell “heatmap” illustrating an embodiment of a method of video analytics in accordance with an aspect of the present systems and methods.

FIG. 9 is a flow diagram showing a series of acts for performing video analysis in accordance with an aspect of the present systems and methods.

FIG. 10 shows a method of operating a video analytics system, according to one illustrated embodiment.

FIG. 11 shows a method of operating a video analytics system to identify events, according to one illustrated embodiment, which may be useful in performing the processing of the method of FIG. 10.

FIG. 12 shows a method of operating a video analytics system to identify events, according to one illustrated embodiment, which may be useful in performing the processing of the method of FIG. 10.

FIG. 13 shows a method of operating a video analytics system to identify events, according to one illustrated embodiment, which may be useful in performing post-processing.

FIG. 14 shows a method of operating a video analytics system to identify events, according to one illustrated embodiment, which may be useful in performing post-processing.

FIG. 15 shows a method of operating a video analytics system to identify events, according to one illustrated embodiment, which may be useful in performing post-processing.

FIG. 16 shows a method of operating a video analytics system to identify events, according to one illustrated embodiment, which may be useful in performing post-processing.

FIG. 17 shows a method of operating a video analytics system to identify events, according to one illustrated embodiment, which may be useful in performing post-processing.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with video analysis systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein and in the claims, the term “video” and variations thereof, refers to sequentially captured images or image data, without regard to any minimum frame rate, and without regard to any particular standards or protocols (e.g., NTSC, PAL, SECAM) or whether such includes specific control information (e.g., horizontal or vertical refresh signals). In many typical applications, the image capture rate may be very slow or low, such that smooth motion between sequential images is not discernable by the human eye

The headings and Abstract of the Disclosure provided herein are for convenience only and do not interpret the scope or meaning of the embodiments.

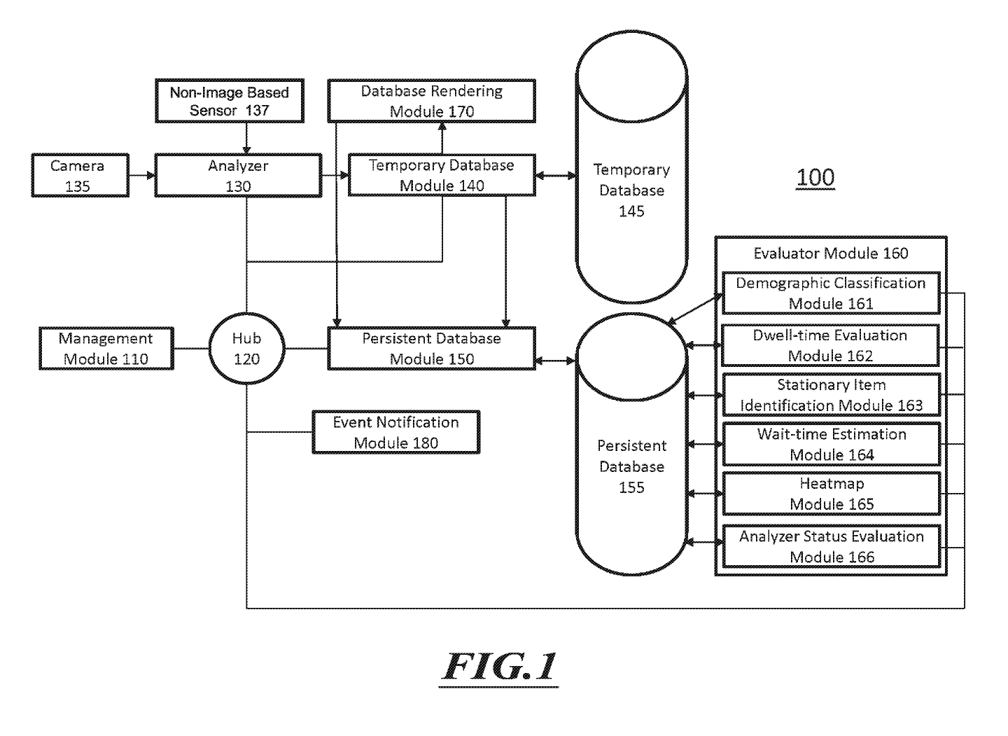

FIG. 1 shows a diagram of an embodiment of a video analysis system 100 suitable for running or automatically performing video analytics. A management module 110 may control the operation of video analysis system 100. A user of video analysis system 100 may interact (e.g., issue commands) with video analysis system 100 through management module 110. Management module 110 may control the flow of information through a hub 120. Hub 120 may be a central module or one of a number of control modules of video analysis system 100 through which information, videos and/or commands flow. Hub 120 may allow for communication between management module 110 and an analyzer 130, a temporary database module 140, a persistent database module 150, an evaluator dispatch module 160 and an event notification module 180. Persons of skill in the art would appreciate that additional components of video analysis system 100 may be in communication with management module 110 through hub 120 or an alternative communications channel. In some instances communications between the camera 135 and image analyzer 130 may take place over a dedicated communications channel, for example a coaxial cable or other channel that is not employed for other communications. Such may be particularly useful for analog cameras. In other instances, the communications may take place over a non-dedicated communications channel, for example over a network, for instance an extranet, intranet, or the Internet which carries various types of communications. Such may be particularly useful for Internet protocol (IP) cameras.

An analyzer 130 may be connected to a camera 135. Camera 135 may capture video of an area. Camera 135 may be an IP camera such that analyzer 130 and camera 135 operate on and communicatively connect to a network. Camera 135 may be connected directly to analyzer 130 through a universal serial bus (USB) connection, IEEE 1394 (Firewire) connection, or the like. Camera 135 may take a variety of other forms of image capture devices capable of capturing sequential images and providing image data or video. As used herein and in the claims, the term “camera” and variations thereof, means any device or transducer capable of acquiring or capturing an image of an area and producing image information from which the captured image can be visually reproduced on an appropriate device (e.g., liquid crystal display, plasma display, digital light processing display, cathode ray tube display).

The camera 135 may capture sequential images or video of an area. The camera 135 may send the images or video of the area to the analyzer 130 which then processes the images or video to determine occurrences of activity or interest. The area being imaged may be divided into regions. The analyzer 130 may process the images or video from camera 135, or various characteristics of objects (e.g., persons, packages, vehicles) which appear in the images. For example, the analyzer 130 may determine or detect the appearance or absence of an object, the speed of an object moving in the video, acceleration of an object moving in a video, and the like. The analyzer 130 may, for example, determine the rate at which a group of pixels in the video changes between frames. The analyzer 130 may employ various standard or conventional image processing techniques. Analyzer 130 may also identify a path an object takes within or through the area or sequential images. The analyzer 130 may determine whether an object moves between a first region of the area to a second region of the area or whether the object persists within the first region of the area. Further, analyzer 130 may process identifying characteristics of common objects, such as identifying characteristics of people's faces. All of the data created by analyzer 130 may be stored as event records or event metadata with the associated video captured by camera 135 or it may be stored as event records or event metadata in a separate location from a location of the video captured by camera 135. The terms event record and event metadata are used interchangeably herein and in the claims to refer to information which characterizes or describes events, the events typically being events that occur in the area to be monitored and which are automatically discernable by the analyzer 130 from one or more images of the area. Such information may include an event type, event location, event date and/or time, indication of presence, location, speed, acceleration, duration, path, demographic attribute or characteristic, etc.

One or more non-imaged based sensors 137 may detect, measure or otherwise sense information or events in an area or zone. For example, a non-imaged based sensor 137 in the form of an automatic data collection device such as a radio frequency identification (RFID) interrogator or reader may detect the passage of objects bearing RFID transponders or tags. Information regarding events, such as a passage of a transponder, and associated identifying data (e.g., unique identifier encoded in RFID transponder) may be provided to the analyzer 130. For example, employees may wear badges which include RFID transponders. The use of non-imaged based sensor(s) 137 may allow the analyzer 130 to distinguish employees from customer in a total occupancy count, allowing the number of customers to be accurately determined. Such may also allow the analyzer to assess the number or ratio of customers per unit area, the number or ration of employees per unit area, and/or the ratio of employees to customers for a given area or zone.

Events identified by analyzer 130 are used by video analysis system 100 to automatically complete real-time monitoring of an area monitored by camera 135. Events may include identification of a face or a face satisfying certain defined criteria. Events may include identification of movement of an object. Events may include determination of a speed of a moving object or that a speed of a moving object is above, at or below some defined threshold. Events may include determination of an acceleration of a moving object or that an acceleration of a moving object is above, at or below some defined threshold. Events may include identification of a stationary object. Events may include identification of a removed object. Events may include identification of a path along which an object moves or that such a path satisfied certain defined criteria (e.g., direction, location). Also, events may include identification of a certain defined operational state of cameras 135 by analyzer 130. There may exist a plurality of analyzers 130 within video analysis system 100. Analyzer 130 may be connected to two or more cameras 135.

Analyzer 130 may operate in real-time, identifying events which occur from image or video less than several seconds long or a limited number of images or frames may be analyzed at a single time. Also, analyzer 130 is not aware of any other analyzers within analysis system 100 and is therefore incapable of identifying macro events which may be identified by analyzing multiple video streams.

The videos and/or event records or sets of event metadata may be provided from analyzer 130 to a temporary database module 140. Temporary database module 140 may be in communication with temporary database 145. Videos and event records or sets of event metadata sent from analyzer 130 may be stored within temporary database 145 for a period of time. For example, a single image from the video stream may be identified every hour and used as a representative thumbnail image of the video. These thumbnail images may be indexed by temporary database 145. Because video files are comparatively large, huge volumes of digital storage would be required to archive these video feeds. Digital storage media this size are not cost efficient to purchase and maintain. As such, temporary database module may overwrite video stored within temporary database 145 on a first in, first out (i.e., queue) basis to store video being recorded in real-time. While this may be necessary, information contained within this video will be lost without an efficient means of storing events as event records or sets of event metadata which occurred during various times in the video. Temporary database 145 may, for example, have a storage capacity sufficient to store video recorded by camera 130 for 5 to 10 days at the most.

A temporary database rendering module 170 may be in communication with temporary database module 140. Temporary database rendering module 170 may use the index of thumbnail images within temporary database 145 to create a timeline of the video captured by camera 135 which can be sent to remote users through a network connection. Remote users may have limited bandwidth connections to video analysis system 100 and therefore may be unable to efficiently view video captured by camera 135. These thumbnail images may be sent to remote users over low-bandwidth connections, such as wireless data connections, to monitor the operations of video analysis system 100.

The analyzer 130 may create or generate event records or sets of event metadata for each event in the video the analyzer 130. The analyzer 130 may provide the event records or sets of event metadata to a persistent database module 150 from which analyzer 130 may additionally or alternatively provide metadata regarding respective events to persistent database module 150. The event metadata may, for example, include an event type that identifies the type of event (e.g., linger, speed, count, demographic, security), event location identifier, event time identifier, or other metadata that specifies characteristics or aspects of the particular event. Further, persistent database module 150 may pull event information from temporary database 145, via temporary database module 140. Event records or sets of event metadata are stored by persistent database module 150 in a persistent database 155. Event record or sets of event metadata file sizes are small in comparison to the file sizes of videos. Events may be identified and event records or sets of event metadata created by devices other than analyzer 130. For example, a door sensor signals to persistent database module 150 reporting events such as whether a door is open or closed. Persons of skill in the art would appreciate that many events detected, and event records or sets of event metadata, may be generated by devices that do not analyze images or video (i.e., non-analyzers). Persistent database 155 may have a storage capacity sufficient to store event records or sets of event metadata generated by analyzer 130 for the operational lifetime of video analysis system 100. Operational lifetimes of video analysis system may, for example, be on the order of 5 to 10 years or greater.

The video analysis system 100 may optionally include an evaluator module 160 to interface directly with persistent database 155. Evaluator module 160 may include a plurality of sub-evaluator modules such as a demographic classification module 161, a dwell-time evaluation module 162, a stationary item identification module 163, a wait-time estimation module 164, a heatmap module 165 and an analyzer status evaluation module 166. Evaluator module 160 may be automatically started on detection of the occurrence of an event, for instance to evaluate whether or not the event actually occurred in response to a false alarm condition. Evaluator module 160 may operate on a schedule such that an evaluation occurs every minute. Evaluator module 160 may be started based on receipt of an event occurrence signal or event record received from analyzer 130. Evaluations performed by the evaluation modules 160 may create macro-event records or sets of macro-event metadata, which may be stored within persistent database 155 as respective macro event records or sets of macro-event metadata.

Evaluation module 160 does not operate in real-time with video from camera 135. Rather, the evaluation module 160 evaluates information (e.g., event records, event metadata about an event) provided by the analyzer 130. Analyzer 130 provides real-time event identification from a video and the evaluation module 160 performs video analytics on the event data (e.g., event records, event metadata). The evaluation module 160 operates in near-real-time such that events identified by analyzer 130 are processed by evaluation module 160 in a timely manner once the event records or event metadata reach persistent database 155. An event may, for instance, be processed within a minute of the corresponding event record or event metadata being stored within persistent database 155. Some events may be processed after a longer period of time while other events may be processed within seconds of the corresponding event record or event metadata being stored within persistent database 155.

Event records and/or metadata corresponding to events, such as identification of an operational state of cameras 135, may be sent from analyzer 130 to an event notification module 180 and persistent database module 150. In response to identification of macro-events, evaluation module 160 may send a signal indicative of such to event notification module 180. In response, event notification module 180 may generate and send or cause to be sent emails, text messages, or other notices or alerts through a network or other communications connection to receivers external to video analysis system 100.

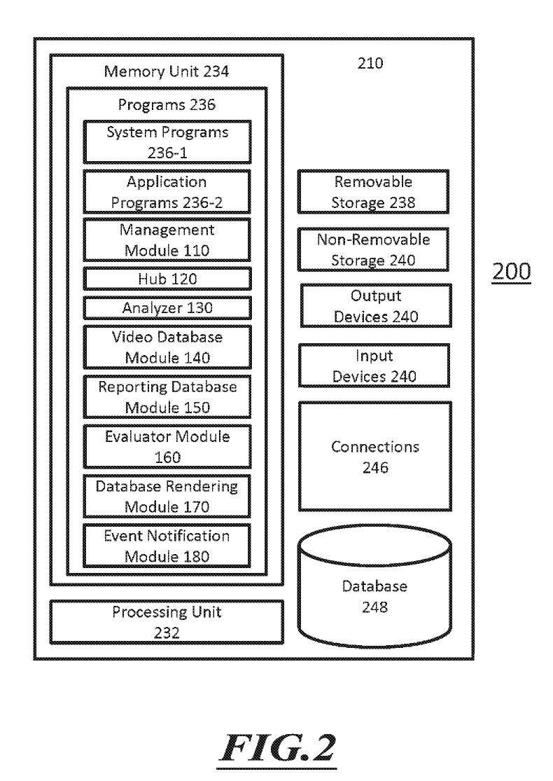

FIG. 2 illustrates a computing architecture 200 suitable for implementing one or more of the components of video analysis system 100. In a basic configuration, computing architecture 200 includes at least one computing system 210 which typically includes at least one processing unit 232 and memory 234. The at least one processing unit or processor 232 may take any of a variety of forms, for example, a microprocessor, digital signal processor (DSP), programmable gate array (PGA) or application specific integrated circuit (ASIC). Memory 234 may be implemented using any non-transitory processor-readable or computer-readable media capable of storing processor executable instructions and/or data, including both volatile and non-volatile memory. For example, memory 234 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of non-transitory storage media suitable for storing information. As shown in FIG. 2, memory 234 may store various software programs 236 and accompanying data. Depending on the implementation, examples of software programs 236 may include one or more system programs 236-1 (e.g., an operating system), application programs 236-2 (e.g., a Web browser), management modules 110, hubs 120, analyzers 130, video or temporary database modules 140, reporting or persistent database modules 150, evaluator modules 160, database rendering module 170, event notification modules 180, and so forth.

Computing system 210 may also have additional features and/or functionality beyond its basic configuration. For example, computing system 210 may include removable storage media drive 238 operable to read and/or write removable non-transitory storage medium and non-removable storage media drive 240 operable to read and/or write to non-removable non-transitory storage media. Various types of processor-readable or computer-readable media have previously been described. Computing system 210 may also have one or more input devices 244 such as a keyboard, mouse, pen, voice input device, touch input device, measurement devices, sensors, and so forth. Computing system 210 may also include one or more output devices 242, such as displays, speakers, printers, and so forth.

Computing system 210 may further include one or more communications connections 246 that allow computing system 210 to communicate with other devices. Communications connections 246 may give database rendering module 170 and event notification module 180 and persistent database connection module 190 accesses to the Internet or other networked and/or non-networked resources. Communications connections 246 may take the form of one or more ports or cords for wired and/or wireless communications using electrical, optical or radio (RF and/or microwave) signals. Evaluator module 160 may access communication connections 246 directly. Further, camera 135 (e.g., IP camera) may be connected to computing system 210 through communication connections 246. Analyzer 130 may be connected to computing system 210 through communication connections 246. Communication connections 246 may connect additional sensors such as motion detectors, door and window opening sensors, and the like to communicate with computing system 210. Communications connections 246 may include various types of standard communication elements, such as one or more communications interfaces, network interfaces, network interface cards (NIC), radios, wireless transmitters/receivers (transceivers), physical connectors, USB connections, IEEE 1394 connections, cellular data network equipment, and so forth.

Computing system 210 may further include one or more databases 248, which may be implemented in various types of processor-readable or computer-readable media as previously described. Database 248 may include temporary database 145 and persistent database 155. Each temporary database 145 and persistent database 155 may exist on different non-transitory storage media or on two or more partitions of a single non-transitory storage media source.

Event records and/or event metadata generated by analyzer 130 are used by video analysis system 100 to complete real-time monitoring of an area monitored by one or more cameras 135. Event records and/or metadata may be stored in persistent database 155. Evaluator module 160 may interact with the sorted event records and/or event metadata to determine characteristics of events associated with or occurring in the area monitored by camera 135.

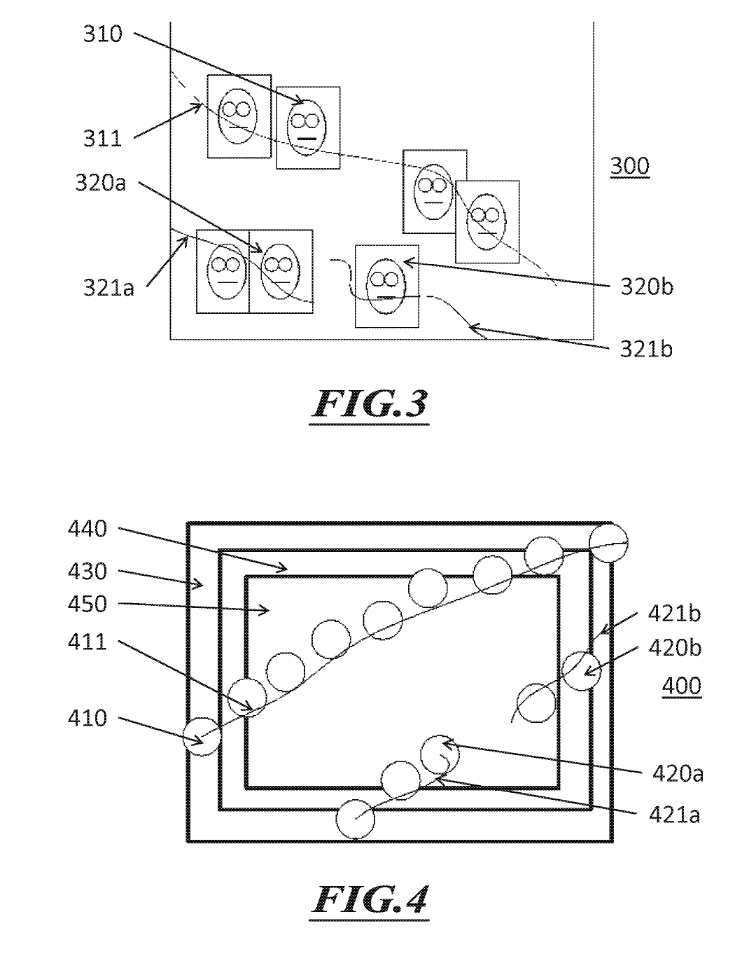

FIG. 3 shows an image of area 300. Video was taken of area 300 over a period of time by camera 135 and analyzer 130 processed this video to identify events. A first face 310 and second face 320a and 320b have been identified and tracked. Face detection may be performed using any of a number of suitable conventional algorithms. Many algorithms implement face-detection as a binary pattern-classification task. That is, the content of a given part of a frame of a video may be transformed into features, after which a classifier within analyzer 130, trained on example faces, decides whether that particular region of the image is a face, or not. The analyzer 130 can identify regions of an image or frame of video which may be a face. The face in an image or frame of video has intrinsic properties and metrics. The ratios of the distances between the eyes, nose and mouth have information that can be used to determine the gender of an individual, their age and ethnicity. A demographic classification evaluator 161 may be used to confirm the identification of the face and identify further demographic characteristics of the face. These metrics may be identified as an event and stored as an event record or event data in persistent database 155 by demographic classification evaluator 161 including information specifying a location of the face and where the face moves in time as determined by analyzer 130. Advantageously, with such small amounts of information representing the events in the video, remote connections to video analysis system 100 do not require high speed broadband to deliver high volumes of information.

The analyzer 130 may further be able to determine the speed of moving objects, such as faces 310, 320a and 320b by examining the number of pixels an object represented by a group of pixels shifts between frames of video. This information may further be extrapolated to find acceleration values. Velocities and accelerations events may be associated with the faces 310, 320a and 320b.

First face 310 is seen to move along path 311, and second face 320a and 320b is seen to move along paths 321a and 321b. Path 311 may be created by analyzer 130 and associated with the face 310 from acceleration and velocity information of face 310.

Paths 321a and 321b were created by analyzer 130. Evaluator module 160 may be capable of determining whether the faces 320a and 320b tracked along paths 321a and 321b respectively. Demographic, acceleration and velocity information of faces 320a and 320b may be used by evaluator module 160 to determine whether faces 320a and 320b are associated with a single person.

By identifying track 311 for face 310, the events recording the facial characteristics of face 310 throughout the video can be viewed as a single face. Demographic classification evaluator 161 may use all of these facial characteristics recorded to produce high quality demographic classification result for face 310. Having the ability to compare and combine information from many frames of a video is not easily available without the creation of events. By examining many images of face 310, the demographic classification of face 310 will be much more accurate.

There may be an algorithm within demographic classification module 161 which process face metric information and eliminates faces with low-confidence scores which may reduce the accuracy of demographic classification evaluator 161 should they be used. By eliminating such low-confidence scores, a more accurate result may be achieved.

FIG. 4 shows an area 400. Video was taken of area 400 over a period of time by camera 135 and analyzer 130 processed this video to identify events. A first object 410 and a second object 420a and 420b have been identified and tracked moving from a first region 430 into a buffer region 440 and finally into a second region 450. An event may be created by analyzer 130 when an object transitions between first region 430 and second region 450. Further, first object 410 and second object 420a have been identified and tracked moving from second region 450 into a buffer region 440 and finally into first region 430. An event may be created by analyzer 130 when first object 410 and second object 420b transition between second region 430 and first region 450.

The analyzer 130 may be able to determine the speed of moving objects 410, 420a and 420b by examining the number of pixels objects 410 and 420 shift respectively between frames of video. This information may further be extrapolated to find acceleration values. Velocities, accelerations may be associated with objects 410, 420a and 420b.

First object 410 is seen to move along path 411, and second object 420 is seen to move along paths 421a and 421b. Path 411 may be created by analyzer 130 and associated with object 410 from the acceleration and velocity information of object 410.

Paths 421a and 421b were created by analyzer 130. Evaluator module 160 may be capable of connecting paths 421a and 421b as the evaluator knows an object cannot appear and disappear from region 450 without exiting through region 430. The number of other recent transition events between first region 430 and second region 450 near paths 421a and 421b may be used to associate paths 421a and 421b. Events may have been generated for path 411 entering and leaving second region 450 in advance of events for path 421 a entering second region 450 and path 421b exiting region 450. Since FIG. 4 shows no other transitions were identified by analyzer 130 entering second region 450 other than object 410, evaluator module 160 may be able to associate object 420a with object 420b, or collectively object 420. Should objects 420a and 420b be identified within region 450 while object 410 is identified within region 450, evaluator module 160 may be able to associate objects 420a and 420b since object 410 is associated with path 411 which was found to both enter region 450 and exit region 450 so is likely not associated with either of object 420a or object 420b. Should track 411 of object 410 not be identified both entering and exiting region 450, evaluator module 160 may not have been able to associate object 420a with object 420b.

A dwell-time evaluation module 162 may be used to determine how long each of objects 410 and 420 dwelled within region 450 by examining the events created by analyzer 130 and stored within persistent database 155. Noting the time objects 410 and 420 each entered region 450 from region 430 and exited region 450 to region 430, an amount of time spent by objects 410 and 420 within region 450 can be determined by dwell-time evaluation module 162. Dwell-time evaluation module 162 may store the dwell-time of objects 410 and 420 within region 450 as macro events in persistent database 155.

This information is not easily determined without the creation of events as the entrance to region 450 and the exit from region 450 may be separated by a great deal of time. Analyzer 130 may not be able to hold more than a few seconds of video data within it at one time. An evaluator is needed to examine the events created by analyzer 130 over relatively large periods of time to determine dwell-time of an object within a region.

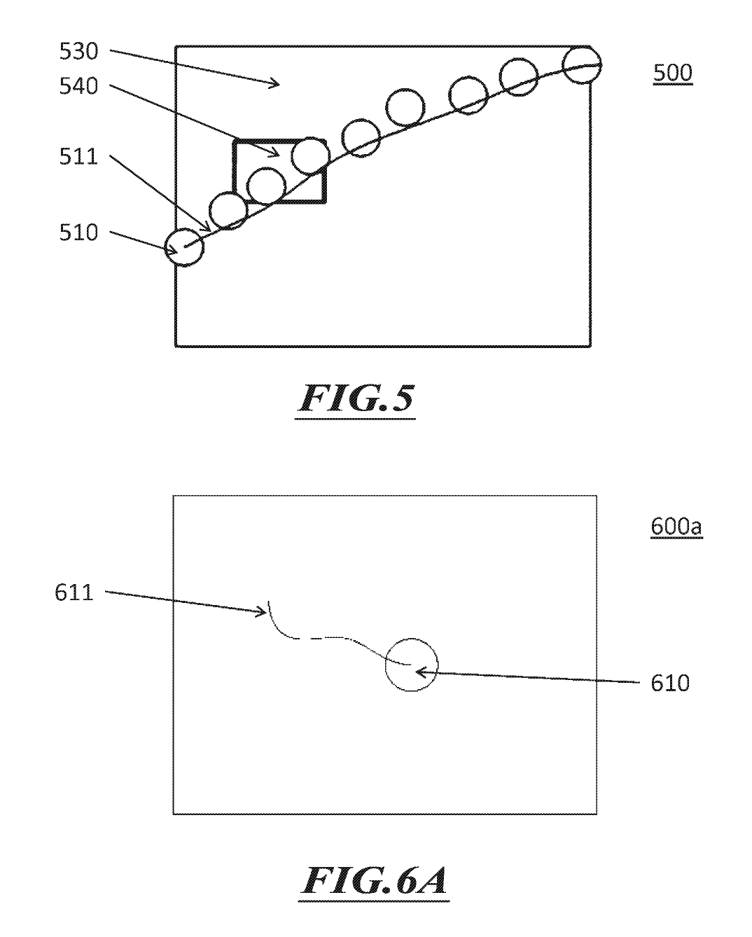

FIG. 5 shows an area 500. Video was taken of area 500 over a period of time by camera 135, and analyzer 130 processed this video to identify events. An object 510 has been identified and tracked moving into a region 540. Object 510 enters region 540 and exits it back to general region 530 along path 511. An event may be created when object 510 is identified within region 540.

A dwell-time evaluation module 162 may be used to determine how long object 510 dwelled within region 540 by examining the events created by analyzer 130 and stored within persistent database 155. Noting the time object 510 was identified within region 540 along with the velocity and acceleration of object 510, an amount of time spent by object 510 within region 540 may be determined by dwell-time evaluation module 162. Dwell-time evaluation module 162 may store the dwell-time of object 510 within region 540 as macro events in persistent database 155.

This information is not easily determined without the creation of events such as the identification of an object within region 540. Analyzer 130 may not be able to hold more than a few seconds of video data within them at one time. And evaluator is needed to examine the events created by analyzer 130 over periods of time to determine dwell-time of an object within a region.

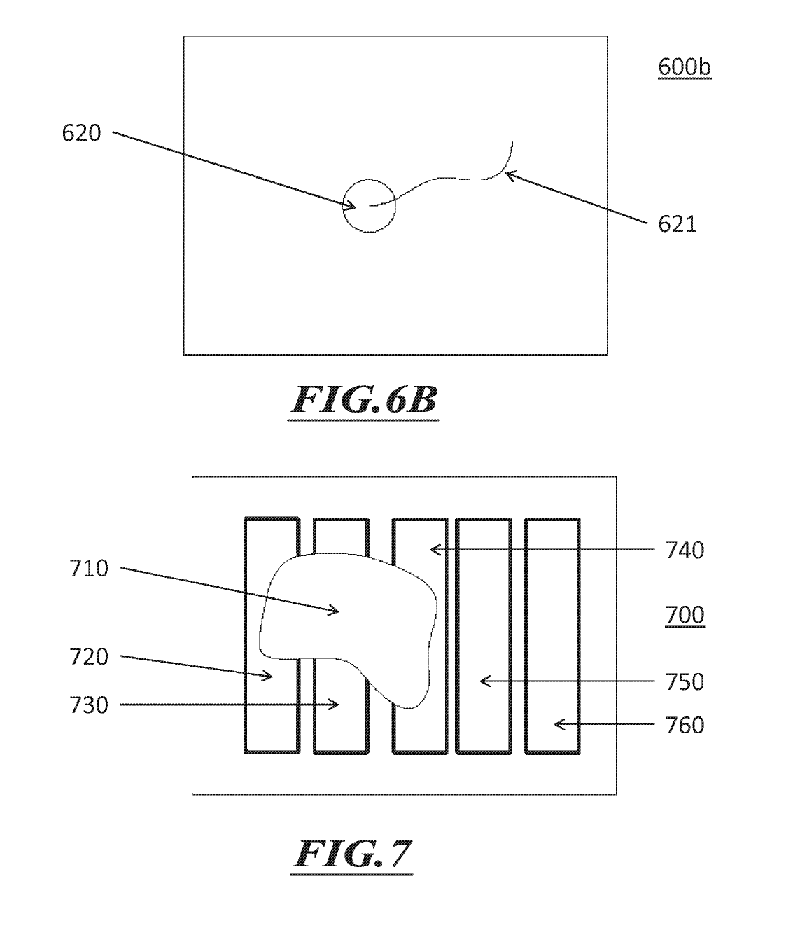

FIG. 6A shows an area 600a. Video was taken of area 600a over a period of time by camera 135 and analyzer 130 processed this video to identify events. An object 610 has been identified as a stationary object. Such an object may, for example, be unattended baggage, a parked car, a stationary person, and the like. Object 610 was tracked along a path 611 but stopped moving. Analyzer 130 created an event due to the stationary object 610.

The analyzer 130 may be able to determine the speed of moving object 610 by examining the number of pixels object 610 shifts between frames of video. This information may further be extrapolated to find acceleration values. Velocities and accelerations events may be associated with object 610.

Object 610 is seen to move along path 611. Path 611 may be created by analyzer 130 and associated with object 610 from the acceleration and velocity information of object 610. When the object 610 ceased movement, a further event may have been created signifying the identification of a stationary object. Analyzer 130 may only have enough memory to store several seconds of video. Since object 610 may have started to move several seconds later, an alert may not be sent to notification module 180 by analyzer 130.

A stationary item identification module 163 may be used to determine whether or not object 610 has become stationary after moving along a track 611. Stationary item identification module 163 confirms that track 611 has led to or from the object 610 and may look at events from several minutes of video to determine whether object 610 again begins moving. Object 610 may have moved in such a way that it was not identified by analyzer 130 for a few seconds. While this may have confused analyzer 130 which may have resulted in a stationary object event being created, by examining several minutes of video events stationary item identification module 163 may be able to confirm object 160 has become stationary or that object 610 again began moving. Stationary item identification module 163 may be scheduled to run five seconds after a stationary object event was identified. Persons of skill in the art would appreciate that longer or shorter periods of time may be spent waiting to run stationary item identification module 163 after a stationary object event occurs. Stationary item identification module 163 may send a macro event to event notification module 180 and persistent database 155 should it determine object 610 has indeed become stationary. Stationary item identification module 163 within analysis system 100 may reduce the number of false alarms triggered by analyzer 130. Such reductions in false alarms would not be readily possible without the generation of events by analyzer 130.

FIG. 6B shows an area 600b. Video was taken of area 600b over a period of time by camera 135 and analyzer 130 processed this video to identify events. An object 620 has been identified as a removed object. Such an object may, for example, be unattended baggage which was removed from a location, a parked car which was driven away, persons who dwelled within a region for a period of time, and the like. Object 620 may be tracked moving along a path 621 from a stationary position. Analyzer 130 created an event due to the once stationary object 620 beginning removed from area 600b.

The analyzer 130 may be able to determine the speed of removed object 620 by examining the number of pixels object 620 shifts between frames of video from camera 135. This information may further be extrapolated to find acceleration values. Velocities and accelerations events may be associated with object 620.

Object 620 may be seen to move along path 621. Path 621 may be created by analyzer 130 and associated with object 620 from the acceleration and velocity information of object 620. When the object 620 begins moving from a stationary position, an event may have been created signifying the identification of the movement of a formerly stationary object, such as the removal of an object.

A stationary item identification module 163 may be used to determine whether or not object 620 can be associated with a stationary object 610 of FIG. 6A. Stationary item identification module 163 may confirm that track 611 has lead to object 610 becoming stationary in a similar location to where object 620 began its own movement. Stationary item identification module 163 may associate object 610 with object 620 if such a relationship can be created.

Should stationary item identification module 163 notice the removal of object 620 from a region associated with object 610 without the presence of track 621, it may send a macro event to event notification module 180 and persistent database 155 regarding the removal of object 620 in the absence of track 621.

By examining several seconds or minutes of events, the stationary item identification module 163 may be able to confirm that object 610 has begun moving, for example, along track 621. Stationary item identification module 163 may send a macro event to the persistent database 155 which is then used by another evaluator, such as dwell-time evaluation module 162 should dwell-time evaluation module 162 lose track of an object within a region, such as object 510 of FIG. 5. In such an event, an event may not be sent to notification module 180 regarding object 610 becoming stationary. Stationary item identification module 163 within analysis system 100 may reduce the number of false alarms triggered by analyzer 130. Such reductions in false alarms would not be readily possible without the generation of events by analyzer 130.

FIG. 7 shows a queuing zone 700, such as a security line at an airport. Within queuing zone 700 there exists an area 720, an area 730, an area 740, an area 750 and an area 760. Each area 720, 730, 740, 750 and 760 is representative of video taken over a period of time by a respective camera 135. Each video stream was processed by analyzer 130 or a similar analyzer. Further, an object 710 has been identified. Object 710 is representative of an amount of activity with areas 720, 730 and 740. Events are created by cameras which see activity in their respective area.

A wait-time estimation module 164 may determine a queue wait-time (i.e., actual, average or median time for an individual to move through a queue or line). Wait-time estimation module 164 interacts with persistent database 155 to determine which areas have reported activity. The analyzer(s) associated with the five cameras may be able to determine the queue has not reached areas 720, 730 and 740 or entered areas 750 or 760. By knowing historical data associated with queues in the queuing zone, an estimate of the waiting time for the queuing zone can be determined by wait-time estimation module 164. The wait-time estimation module 164 may report the determined wait time through event notification module 180. For example, for displaying via a sign so individuals entering queuing zone 700 are given an estimate of their wait-time.

Historical data may be generated by video analysis system 100 and stored in persistent database 155. The wait-time estimation module 164 may create or generate a macro event record or metadata in response to a queue of a given size decreasing over a given period without any additional influx of people. Over time, the video analysis system 100 learns how to estimate wait-times more accurately, based on the macro event records or macro event metadata stored within persistent database 155.

In some embodiments, one individual camera 135 may not be able to assess the amount of activity within queuing region 700 due to its size. Therefore, multiple cameras are needed to monitor queuing region 700, and event records and/or event metadata created through this multi-camera monitoring should be examined as a whole by the video analysis system 100. For instance, a large amount of activity may be found in area 760 with little activity in one or more other regions. This may signify an influx of people into a queuing region with little line. A large amount of activity found in area 720 with little activity in any other region may signify a line which is long enough to exist in 720 but not in any other region.

This line would have a relatively short wait-time as compared to a line which has activity found in areas 720, 730 and 740, as shown in FIG. 7. Persistent database 155 and event records and/or event metadata from individual cameras facilitate the creation of macro events through the implementation of wait-time evaluator module 164.

The video analysis system 100 may optionally include one or more analyzer status evaluation The video analysis system 100 may optionally include one or more 166 configured to determine an operational state or condition of the analyzer(s) 130, for example, whether the analyzer 130 is functioning properly. Analyzer status evaluation module 166 may execute periodically. Analyzer status evaluation module 166 may merely access persistent database 155 after a period of time to determine whether or not event records and/or event metadata are being generated by analyzer 130. Should a sufficiently long time (e.g., threshold time) pass without the generation of an event records or event metadata, or should a sufficiently large number (e.g., threshold quantity) of event records or event metadata be generated over a short period of time, the analyzer status evaluation module 166 may generate a macro event record and/or macro event metadata, alerting event notification module 180 of the aberrant condition or behavior of analyzer 130.

Management module 110 may be accessed remotely by users looking for information regarding the operation of analysis system 100. Events have relatively small file sizes and as such are easily transmitted over remote connections with limited bandwidth. Therefore, due to the small file size of events, a near-real-time connection can be created between a remote user and the persistent database 155. Persistent database module 150 is capable of supplying management module 110 with information requested by management module 110 from persistent database 155 in near-real-time, even over limited bandwidth connections. Management module 110 can therefore generate reports on the operation of analysis system 110 in near-real-time. Systems which rely on video, such as that stored with in temporary database 140, cannot access information in near-real-time due to the size of the video files.

Further, because of the size of events, it is relatively easy to efficiently backup persistent database 155 through a remote connection to management module 110. By allowing offsite backup of persistent database 155, information of events occurring far in the past and over several sites can be brought together in a single place. Further macro events may be able to be identified from this information.

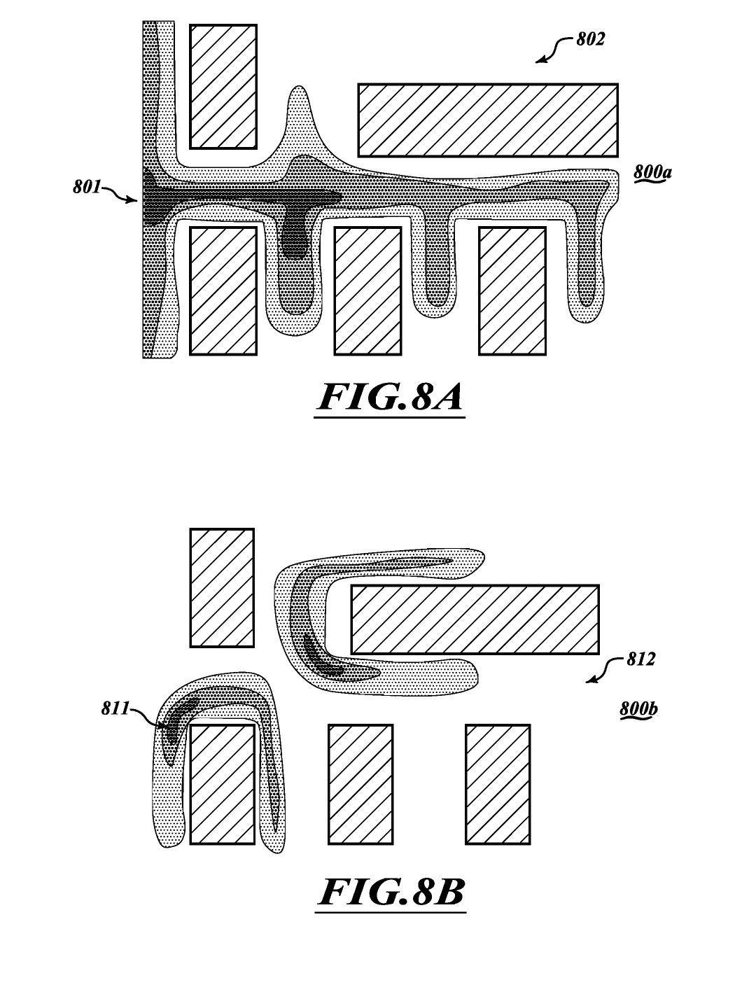

FIG. 8A shows a track “heatmap” in a commercial location. FIG. 8B is an image illustrating a dwell heatmap in a commercial location. A heatmap is a graphical representation of data where measured or otherwise determined values of a variable indicative of use (e.g., frequency of passage, dwell time) in a two-dimensional area are represented in a map format as colors or shades of grey. Such may be overlaid on a captured image or video frame of the two-dimensional area. In FIGS. 8A and 8B, dark grey is indicative of relatively “hot” or frequently traveled spots or locations whereas light grey is indicative of relatively “cold” or infrequently traveled spots or locations. Analyzer 130 may identity tracks of objects moving in area 800a or 800b and where these objects dwell or linger in area 800a or 800b from the images or video acquired or captured by camera 135. Event records and/or event metadata representing the track information may be stored within persistent database 155. As used herein and in the claims, the term “heatmap” and variations thereof such as map corresponds to such a mapped representation of use (e.g., frequency of passage, dwell time) of an area or portion thereof represented in two or more colors or shades (e.g., shades of grey scale). Typically, the variable employed in generating such will be indicative of frequency of use or passage, but may not be indicative of any actually measured heat or thermal characteristic. Although, in some environments, the variable may actually be a measured heat or thermal characteristic, for example, where infrared sensitive cameras are employed. When using thermal imaging, relatively hot spots or locations are typically indicative of a presence of a relatively larger number of people, and hence a spot or location of frequent use. Relatively cold spots or locations are typically indicative of an absence of large numbers of people, and hence a sport location of infrequent use. Heatmap module 165 may be executed once track information and dwell or linger times of objects moving in area 800a or 800b are available within persistent database 155.

Heatmap module 165 may be capable of producing track heatmaps, as seen in FIG. 8A, and dwell or linger heatmaps, as seen in FIG. 8B.

In particular, FIG. 8A shows the path people have taken in the field of view of camera 135 ignoring how long or the amount of time these people took to travel the path or how long they stayed or lingered at any particular spot. Dark grey indicates a frequently travelled path whereas light grey indicates a path infrequently or rarely travelled. Non-colored spots or locations, or spots or locations which still show the captured camera image, indicate that nobody walks in these areas of the region. Heatmap 166 may produce track heatmaps by examining a plurality of tracks such as paths 311 and 411 of FIGS. 3 and 4 respectively and summarizing this information. For example, heatmap module 165 may assign colors based on frequency of use to the various sports or locations. For instance, regions of area 800a may be assigned a relatively darker color or shade where many paths or tracks have occurred, such as region 801. Areas where no or relatively few tracks have occurred may be assigned a relatively lighter color or shade or even be uncolored (e.g., white), such as region 802.

In particular, FIG. 8B shows the areas where people have lingered (e.g., spent a relatively long time in one place sampled at second intervals) in the field of view of camera 135. Dark grey indicates spots or locations where people have lingered (dwelled) a long time whereas light grey indicates areas where people rarely or infrequently linger. Non-colored sports or locations (e.g., white), or spots or locations which still show the camera image, may indicate nobody has spent any time in that area. Dwell or linger heatmaps may be produced. Heatmap module 166 may produce dwell or linger heatmaps by examining a plurality of tracks, such as paths 311 and 411 of FIGS. 3 and 4, respectively, and summarizing this information. For example, heatmap module 166 may assign colors or shades based on length and/or frequency of occupancy of a spot or location. For instance, regions of area 800b may be assigned a relatively darker color or shade where dwelling by people has occurred, such as region 811, while areas where no dwelling by people has occurred may be assigned a relatively lighter color or shade (e.g., white), such as region 812.

The track and dwell heatmaps are not mutually exclusive. For example, a map or visual representation may have areas with high traffic indicated in dark grey (i.e., track heatmap) coincide with areas where people tend to stand for a long time, also indicated in dark gray (i.e., dwell heatmap).

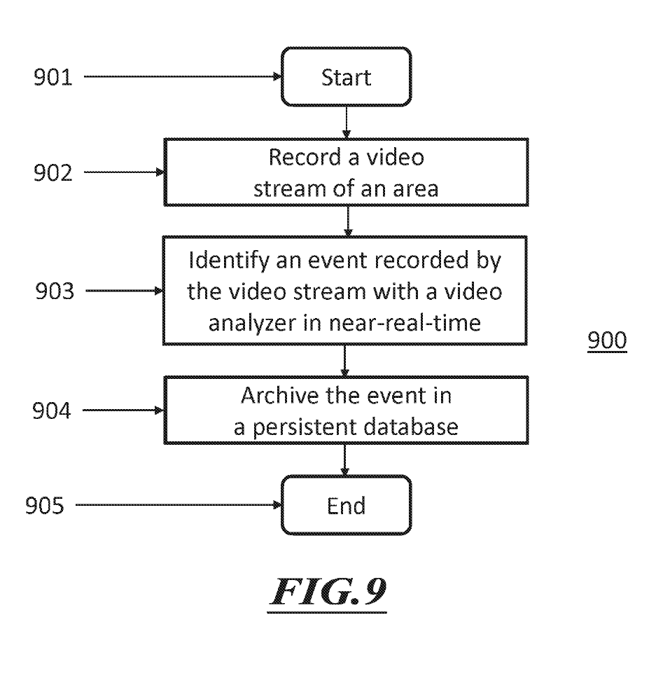

FIG. 9 shows a method 900 of performing video analytics, according to one illustrated embodiment.

At 901, method 900 starts.

At 902, a video stream of an area is recorded. The video stream may be recorded by camera 135, for instance.

At 903, an event recorded by the video stream is identified with a video analyzer 130 in near-real-time. The analyzer 130 may identify an event such as identifying a face, identifying a moving object, determining a speed of the moving object, determining an acceleration of the moving object, identifying a stationary object, identifying a removed object, identifying a path taken by an object moved between a first region of the area and a second region of the area, and identifying an operational state of the video analysis system.

At 904, the event is archived in the persistent database 155. As the analyzer 130 has identified the event, and since the size of an event file may be relatively small, this file can be stored within the persistent database 155 for archival purposes.

At 905, method 900 ends.

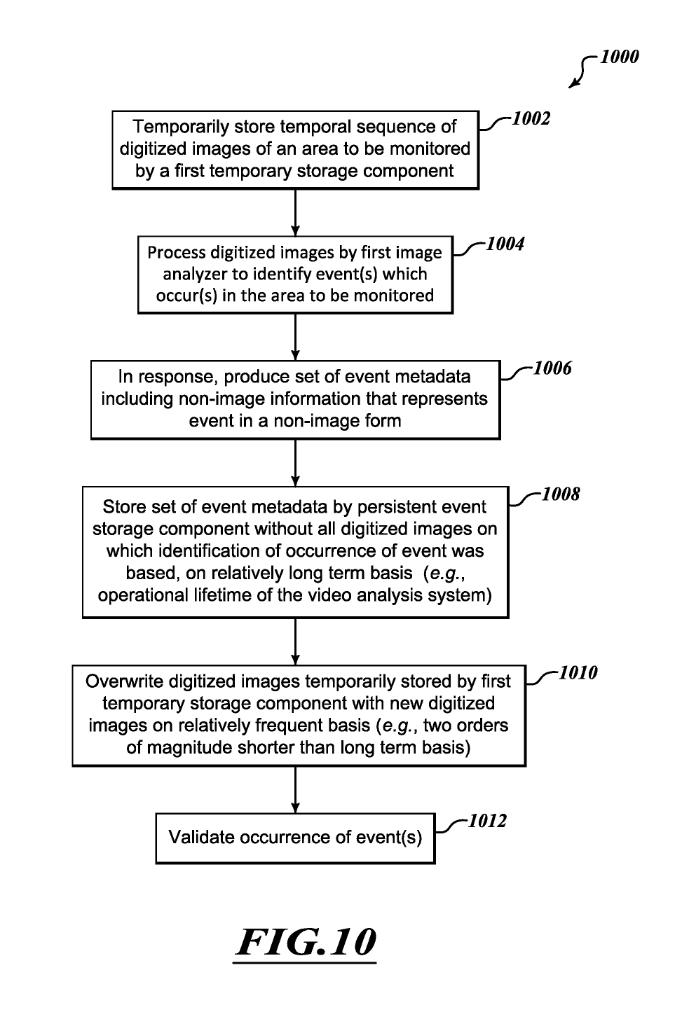

FIG. 10 shows a method 1000 of operating a video analytics system, according to one illustrated embodiment.

At 1002, a video analytics system temporarily stores a temporal sequence of digitized images of an area to be monitored. For example, the digitized images may be stored by a first temporary storage component which includes at least one non-transitory storage medium to which the digitized images are temporarily stored.

At 1004, at least one processor of a first image analyzer processes at least a portion of the temporal sequence of the digitized images to identify an occurrence of at least one event of a defined set of events which occurs in the area to be monitored.

At 1006, in response to identification of at least one event, the at least one processor of the first image analyzer produces a set of event metadata including a set of non-image information that represents the at least one event in a non-image form.

At 1008, a persistent event storage component which includes at least one non-transitory storage medium stores the set of event metadata without all of the digitized images on which the identification of the occurrence of the event was based. Such storage is maintained on a relatively long term basis relative to the temporary storage.

At 1010, the digitized images temporarily stored by the at least one non-transitory storage medium of the first temporary storage component are overwritten with new digitized images. Such occurs on a relatively frequent basis. Thus, the temporary storage may be on a first, relatively short term basis, for example maintained for a month, a week, a day, several hours, or less than an hour. In contrast, the relatively long term storage may be for an operational lifetime of the video analysis system, for example 5-10 years or may be at least 2 orders of magnitude longer than the relatively short term storage.

Optionally at 1012, an evaluator may validate an occurrence of events. Such may be performed by comparing two or more event records or sets of event metadata. Such may be performed by comparing event records or sets of event metadata generated from image or video analysis to event records or sets of event metadata generated from non-image or non-video analysis, for instance generated from RFID tracking.

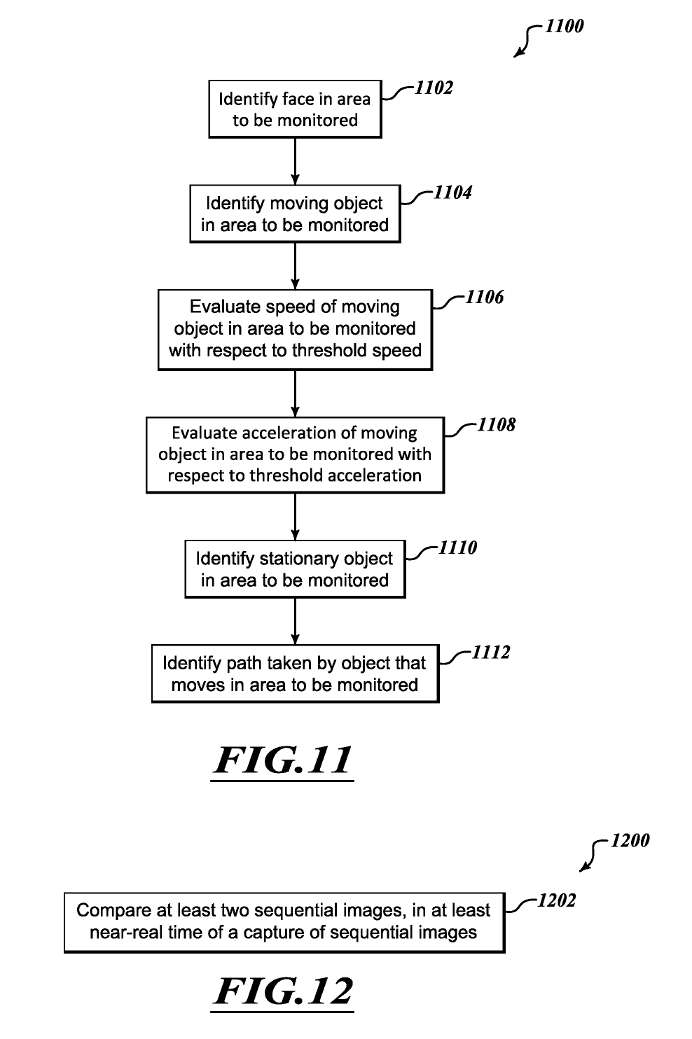

FIG. 11 shows a method 1100 of operating a video analytics system to identify events, according to one illustrated embodiment. The method 1100 may be useful in performing the processing 1004 (FIG. 10) of the method 1000.

At 1102, the analyzer identifies a face in at least a portion of the area to be monitored. The analyzer may analyze one or more images, and may employ any number of image processing techniques suitable to identify faces. Identifying faces may include matching a face to previously faces that have previously appeared, even if the actual identify of the person is unknown. Identifying faces may include identifying one or more demographic characteristic or features of the face to produce generalized demographic information.

Additionally, or alternatively, at 1104, the analyzer identifies a moving object in at least a portion of the area to be monitored. The analyzer may analyze two or more images, and may employ any number of image processing techniques suitable to identify an object in digitized images and movement of the object between digitized images.

Additionally, or alternatively, at 1106, the analyzer determines and/or evaluates a speed of a moving object in at least a portion of the area to be monitored. The evaluation may be with respect to a defined threshold speed. The analyzer may analyze two or more images, and may employ any number of image processing techniques suitable to identify an object in digitized images and a speed of the object.

Additionally, or alternatively, at 1108, the analyzer determines and/or evaluates an acceleration of a moving object in at least a portion of the area to be monitored. The evaluation may be with respect to a defined threshold acceleration. The analyzer may analyze two or more images, and may employ any number of image processing techniques suitable to identify an object in digitized images and acceleration of the object.

Additionally, or alternatively, at 1110, the analyzer identifies the existence of a stationary object in at least a portion of the area to be monitored. Such may be indicative of a safety hazard such as an unaccompanied bag or suitcase. The analyzer may analyze two or more images, and may employ any number of image processing techniques suitable to identify an object in digitized images and persistence of the object between digitized images. Such may use a defined duration threshold.

Additionally, or alternatively, at 1112, the analyzer identifies a path taken by an object that moves between a first portion and a second portion of the area to be monitored. The analyzer may analyze two or more images, and may employ any number of image processing techniques suitable to identify an object in digitized images and path of the object.

FIG. 12 shows a method 1200 of operating a video analytics system to identify events, according to one illustrated embodiment. The method 1200 may be useful in performing the processing 1004 (FIG. 10) of the method 1000.

At 1202, the analyzer compares two sequential digitized images. Sequential means that one image of a given area was captured after another image of the area, although the images may not be closely spaced in time. For example, the images may be captured at intervals of 1 minute, or 5 minutes, etc. Comparison may allow determination of a path, speed, acceleration or persistence of an object in the area.

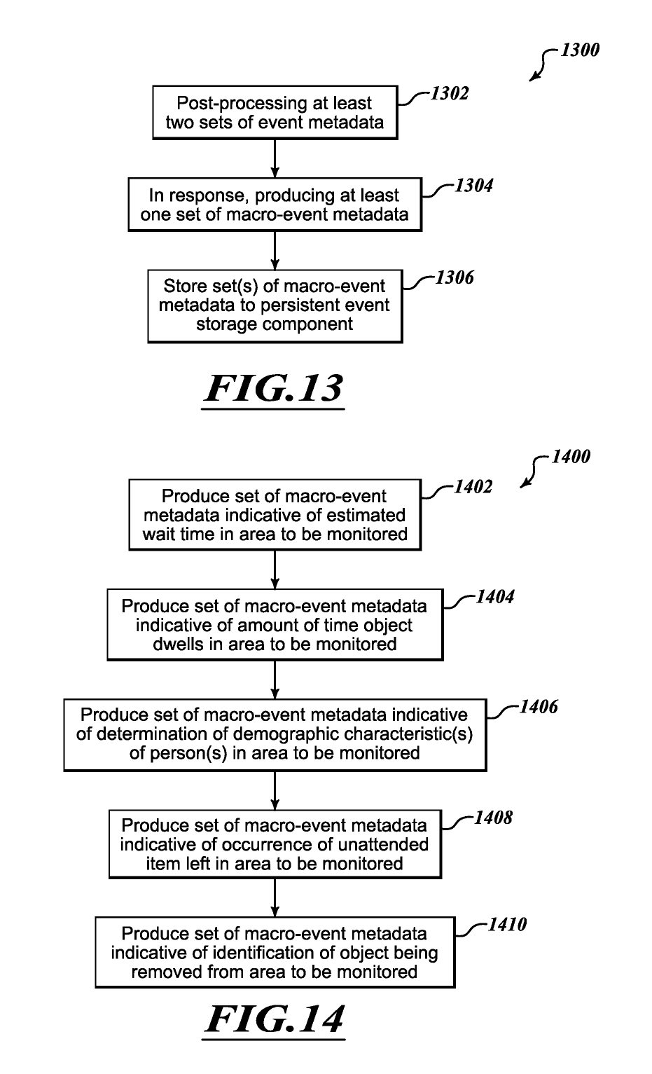

FIG. 13 shows a method 1300 of operating a video analytics system to identify events, according to one illustrated embodiment. The method 1300 may be useful in performing post-processing. Post-processing refers to processing after the initial image analysis which identifies the occurrence of the events captured in the images.

At 1302, at least one processor of an evaluator post-processes at least two sets of event metadata. Such allows examination of evaluation of multiple events, for example to examine trends.

At 1304, the at least one processor of the evaluator, produces at least one set of macro-event metadata in response to the evaluation. Such may facilitate communication and/or storage of abstracted event metadata, without the need to communicate or store all of the image data that were analyzed to detect the occurrence of the events captured therein.

At 1306, the at least one processor of the evaluator stores the at least one set of macro-event metadata to the persistent event storage component.

FIG. 14 shows a method 1400 of operating a video analytics system to identify events, according to one illustrated embodiment. The method 1400 may be useful in performing post-processing.

At 1402, at least one processor of an evaluator produces at least one set of macro-event metadata indicative of an estimation of a wait time in at least a portion of the area to be monitored. The evaluator may determine a length of a line or queue of people, for example from a single digitized image. Additionally, or alternatively, the evaluator may compare two or more sequential digitized images. As noted above, sequential means that one image of a given area was captured after another image of the area, although the images may not be closely spaced in time. Thus, the analyzer may determine the length of time it takes for one or more specific individuals to advance from a first spot (e.g., end of queue) to a second spot (e.g., front of queue). The evaluator may produce a suitable notification such as an alarm.

At 1404, at least one processor of an evaluator produces at least one set of macro-event metadata indicative of an amount of time an object dwells within at least a portion of the area to be monitored. The evaluator may compare two or more sequential digitized images, determining how long a given object has remained in place, and alternatively whether the object is attended or unattended. The evaluator may produce a suitable notification such as an alarm.

At 1406, at least one processor of an evaluator produces at least one set of macro-event metadata indicative of a determination of a demographic characteristic of a person in the area to be monitored. The evaluator may determine such from a single digitized image or from two or more sequential digitized images. Any variety of facial recognition software packages may be implemented for use by the evaluator.

At 1408, at least one processor of an evaluator produces at least one set of macro-event metadata indicative of an occurrence of an unattended item left in the area to be monitored. The evaluator may compare two or more sequential digitized images, determining how long a given object has remained in place, and whether the object is attended or unattended. The evaluator may produce a suitable notification such as an alarm.

At 1410, at least one processor of an evaluator produces at least one set of macro-event metadata indicative of an identification of an object being removed from the area to be monitored. The evaluator may compare two or more sequential digitized images, determining if an object has been removed, and optionally when the object was removed. The evaluator may produce a suitable notification such as an alarm.

FIG. 15 shows a method 1500 of operating a video analytics system to identify events, according to one illustrated embodiment. The method 1500 may be useful in performing post-processing.

At 1502, the evaluator may post-process a first set of event metadata generated by the first image analyzer and at least a second set of event metadata generated based on information sensed by a non-image based sensor. Such may advantageously allow information to be drawn from separate image analyzers, which may, or may not be commonly located.

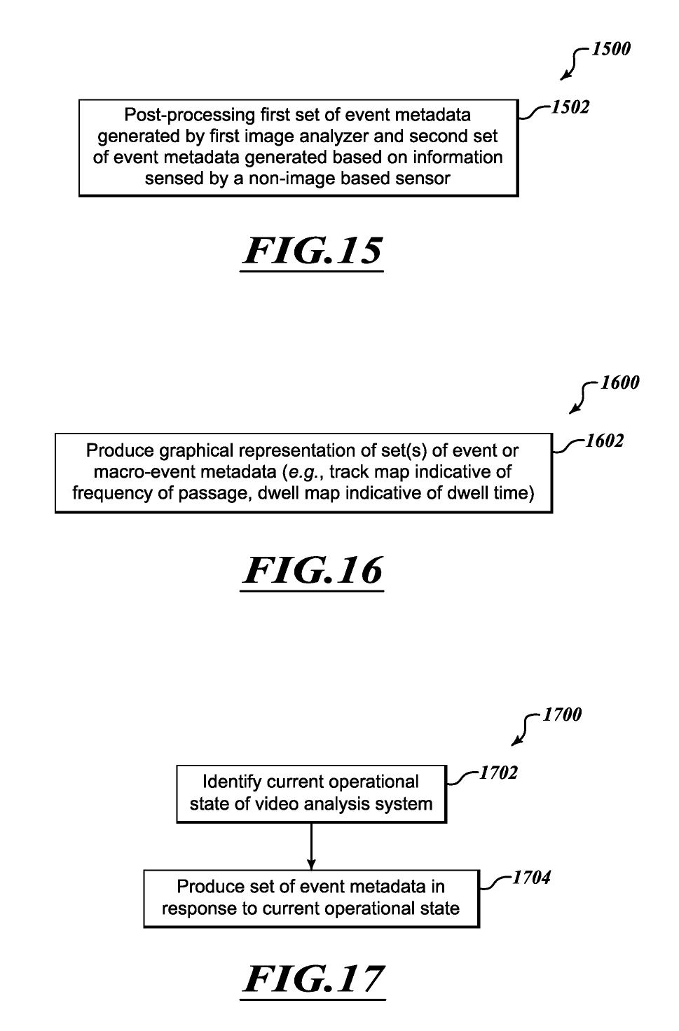

FIG. 16 shows a method 1600 of operating a video analytics system to identify events, according to one illustrated embodiment. The method 1600 may be useful in performing post-processing.

At 1602, at least one processor of an evaluator may produce a graphical representation of at least one of the sets of event metadata or macro-event metadata. Examples of some graphical representations include track and/or dwell maps. Other graphical representation may include any variety of graphs (e.g., pie charts, bar graphs, line graphs) representing any of the information discernable from post-processing. For example, a graph of queue length or customer wait time may be produced, and may be integrated with information about other events, such as promotions, sales, weather, and non-retail events such as holidays or major sports events.

FIG. 17 shows a method 1700 of operating a video analytics system to identify events, according to one illustrated embodiment.

At 1702, video analysis system or video analytics system may identify a current operational state (e.g., functional, on-line, off-line, lack of response, error or error code) of the video analysis system.

At 1704, the video analysis system or video analytics system may produce a set of event metadata in response to identification of at least one defined operational state. For example, a set of event metadata may be produced for all defined operational states, which includes information indicative of the operational state. Alternatively, a set of event metadata may be produced for only a subset all defined operational states, which includes information indicative of the operational state. Such may be produced only for malfunctioning operational states or operational states which prevent full operation of the analytics system. Such may also include providing a notification or an alert regarding the operational state.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. Methods, or processes set out herein, may include acts performed in a different order, may include additional acts and/or omit some acts.

The various embodiments described above can be combined to provide further embodiments. U.S. Provisional Patent Application Ser. No. 61/340,382, filed Mar. 17, 2010, is incorporated herein by reference in its entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a video analysis system, the method comprising:
temporarily storing a temporal sequence of digitized images of an area to be monitored by a first temporary storage component which includes at least one non-transitory storage medium to which the digitized images are temporarily stored;
overwriting the digitized images temporarily stored by the at least one non-transitory storage medium of the first temporary storage component with new digitized images on a first relatively frequent basis;
processing at least a portion of the temporal sequence of the digitized images by a processor of a first image analyzer to identify an occurrence of at least one event of a defined set of events which occurs in the area to be monitored;
in response to identification of at least one event, producing by the at least one processor of the first image analyzer a set of event metadata including a set of non-image information that represents the at least one event in a non-image form; and
storing the set of event metadata by a persistent event storage component which includes at least one non-transitory storage medium to store the set of event metadata without all of the digitized images on which the identification of the occurrence of the event was based, on a second relatively long term basis relative to the first relatively frequent basis.

2. The method of claim 1 wherein identifying the occurrence of at least one event of the defined set of events the at least one processor of the analyzer identify includes comparing at least two of the sequential images, in at least near-real time of a capture of the at least two of the sequential images by at least one camera.

3. The method of claim 1 wherein storing the set of event metadata by a persistent event storage component on the second relatively long term basis includes storing the set of event metadata for an operational lifetime of the video analysis system and overwriting the digitized images temporarily stored by the at least one non-transitory storage medium of the first temporary storage component with new digitized images on the first relatively frequent basis includes overwriting on a period that is at least two orders of magnitude shorter than a period of the second relatively long term basis.

4. The method of claim 1 wherein the first temporary storage component is located locally with respect to at least one camera and the persistent event storage component is located locally with respect to the video analyzer, and further comprising:
transferring the digitized images from the at least one camera to the first image analyzer via a dedicated communications connection; and
transferring the set of event metadata from the first image analyzer to the persistent event storage component via a network communications connection.

5. The method of claim 1 wherein processing at least a portion of the temporal sequence of the digitized images by a processor of a first image analyzer to identify an occurrence of at least one event of a defined set of events which occurs in the area to be monitored includes identifying a face in at least a portion of the area to be monitored, identifying a moving object in at least a portion of the area to be monitored, evaluating a speed of a moving object in at least a portion of the area to be monitored with respect to a threshold speed, evaluating an acceleration of a moving object in at least a portion of the area to be monitored with respect to a threshold acceleration, identifying a stationary object in at least a portion of the area to be monitored, or identifying a path taken by an object that moves between a first portion and a second portion of the area to be monitored.

6. The method of claim 1, further comprising:
post-processing at least two sets of event metadata by at least one processor of an evaluator; and
in response, producing at least one set of macro-event metadata by the at least one processor of the evaluator.

7. The method of claim 6, further comprising:
storing the at least one set of macro-event metadata to the persistent event storage component by the at least one processor of the evaluator.

8. The method of claim 6 producing at least one set of macro-event metadata by the at least one processor of an evaluator includes producing the at least one set of macro-event metadata indicative of at least one of an estimation of a wait time in at least a portion of the area to be monitored, an amount of time an object dwells within at least a portion of the area to be monitored, a determination of a demographic characteristic of a person in the area to be monitored, an occurrence of an unattended item left in the area to be monitored, and an identification of an object being removed from the area to be monitored.

9. The method of claim 6, further comprising:
validating an occurrence of the at least one event by the at least one processor of the evaluator.

10. The method of claim 6 wherein post-processing by the at least one processor of the evaluator includes post-processing a first set of event metadata generated by the first image analyzer and at least a second set of event metadata generated based on information sensed by a non-image based sensor.

11. The method of claim 6, further comprising:
producing a graphical representation of at least one of the sets of event metadata or macro-event metadata by the at least one processor of the evaluator.

12. The method of claim 11 wherein producing a graphical representation of at least one of the sets of event metadata or macro-event metadata includes providing at least one of a track map indicative of a frequency of passage through at least a portion of the area to be monitored or a dwell map indicative of a dwell time in at least a portion of the area to be monitored.

13. The method of claim 1 wherein the persistent event storage component is remotely accessible in near-real-time over a non-dedicated network connection.

14. The method of claim 1, further comprising:
identifying a current operational state of the video analysis system; and
producing a set of event metadata in response to identification of at least one defined operational state.

15. A video analysis system, comprising:
a first temporary storage component communicatively coupled to at least one camera to receive a temporal sequence of digitized images of an area to be monitored from the at least one camera, the first temporary storage component including at least one non-transitory storage medium to which the digitized images are temporarily stored and overwritten with new digitized images on a first relatively frequent basis;
a first image analyzer communicatively coupled to the first temporary storage component, the first image analyzer including at least one processor and at least one non-transitory instruction storage medium that stores processor executable instructions which when executed by the at least one processor cause the at least one processor to process at least a portion of the temporal sequence of the digitized images to identify an occurrence of at least one event of a defined set of events which occurs in the area to be monitored and in response, to produce a set of event metadata including a set of non-image information that represents the at least one event in a non-image form; and
a persistent event storage component communicatively coupled to receive the set of event metadata, the persistent event storage component including at least one non-transitory storage medium to store the set of event metadata without all of the digitized images on which the identification of the occurrence of the event was based on a second relatively long term basis with respect to the first relatively frequent basis.

16. The video analysis system of claim 15 wherein the processor executable instructions cause the at least one processor of the analyzer to identify the occurrence of at least one event of the defined set of events based on a comparison at least two of the sequential images, in at least near-real time of the capture of the at least two of the sequential images by the at least one camera.

17. The video analysis system of claim 15 wherein the second relatively long term basis is equal to an operational lifetime of the video analysis system and the first relatively frequent basis is at least two orders of magnitude shorter than the second relatively long term basis.

18. The video analysis system of claim 15 wherein the first temporary storage component is located locally with respect to the at least one camera and communicatively coupled to the first image analyzer via a dedicated communications connection and the persistent event storage component is located locally with respect to the video analyzer and communicatively coupled to the first temporary storage component via a network communications connection.

19. The video analysis system of claim 15 wherein the processor executable instructions cause the at least one processor of the image analyzer to automatically process the images for, and produce the set of event metadata in response to, an identification of a face in at least a portion of the area to be monitored, an identification of a moving object in at least a portion of the area to be monitored, an evaluation of a speed of a moving object in at least a portion of the area to be monitored with respect to a threshold speed, an evaluation of an acceleration of a moving object in at least a portion of the area to be monitored with respect to a threshold acceleration, an identification of a stationary object in at least a portion of the area to be monitored, or an identification of a path taken by an object that moves between a first portion and a second portion of the area to be monitored.

20. The video analysis system of claim 15, further comprising:
an evaluator communicatively coupled to the persistent event storage component, the evaluator including at least one processor and at least one non-transitory instruction storage medium that stores processor executable instructions which when executed by the at least one processor cause the at least one processor to post-process at least two sets of event metadata and in response produce at least one set of macro-event metadata.

21. The video analysis system of claim 20 wherein the processor executable instructions cause the at least one processor of the evaluator to store the at least one set of macro-event metadata to the persistent event storage component.

22. The video analysis system of claim 20 wherein the processor executable instructions cause the at least one processor of the evaluator to produce the at least one set of macro-event metadata indicative of at least one of an estimation of a wait time in at least a portion of the area to be monitored, an amount of time an object dwells within at least a portion of the area to be monitored, a determination of a demographic characteristic of a person in the area to be monitored, an occurrence of an unattended item left in the area to be monitored, and an identification of an object being removed from the area to be monitored.

23. The video analysis system of claim 20 wherein the processor executable instructions cause the at least one processor of the evaluator to validate an occurrence of the at least one event.

24. The video analysis system of claim 20 wherein the processor executable instructions cause the at least one processor of the evaluator to post-process the at least two sets of event meta data in the form of a first set of event metadata generated by the first image analyzer and at least a second set of event metadata generated based on information sensed by a non-image based sensor.

25. The video analysis system of claim 20 wherein the processor executable instructions cause the at least one processor of the evaluator to produce a graphical representation of at least one of the event metadata or macro-event metadata.

26. The video analysis system of claim 25 wherein the processor executable instructions cause the at least one processor of the evaluator to produce a graphical representation of at least one of the event metadata or macro-event metadata in the form of at least one of a track map indicative of a frequency of passage through at least a portion of the area to be monitored or a dwell map indicative of a dwell time in at least a portion of the area to be monitored.

27. The video analysis system of claim 15 wherein the persistent event storage component is remotely accessible in near-real-time over a non-dedicated network connection.

28. The video analysis system of claim 15 wherein the processor executable instructions cause the at least one processor of the image analyzer to identify a current operational state of the video analysis system and to produce an set of event metadata in response to an occurrence of at least one defined operational state, and further comprising:
the image capture device; and
at least one non-image based sensor.
